(19) United States
(12) Patent Application Publication
(10) Pub. No.: US 2026/0261319 A1
(43) Pub. Date: Sep. 3, 2026

(54) SPATIAL DECOUPLING METHOD FOR INITIAL SEARCHES IN GEOSYNCHRONOUS EARTH ORBIT SYSTEMS

(71) Applicant: YTTEK Technology Corp., Zhubei City, Hsinchu County (TW)

(72) Inventors: CHUNG-LIEN HO, Zhubei City, Hsinchu County (TW); WEN-CHIANG CHEN, Zhubei City, Hsinchu County (TW)

(21) Appl. No.: 19/390,821

(22) Filed: Nov. 17, 2025

Related U.S. Application Data
(60) Provisional application No. 63/765,434, filed on Feb. 28, 2025.

(51) Int. Cl. H04B 7/06; H04B 7/185

(52) U.S. Cl. CPC H04B 7/0639; H04B 7/1851

(57) ABSTRACT

The present invention discloses a spatial decoupling method for initial searches in Geosynchronous Earth Orbit (GEO) systems. The method comprises the following sequential steps: Step 1 (Decoupling): Analyzing a spatial selectivity of a receive (Rx) beamforming output and performing spatial decoupling; Step 2 (1^{st} PLD in 2^{nd} Search Space): Performing a first (1^{st}) peak location detection (PLD) in a retrograded second (2^{nd}) search space using a given peak location (PL) guess from a decoupled first (1^{st}) search space; Step 3 (2^{nd} PLD in 1^{st} Search Space): Performing a second (2^{nd}) PLD in the decoupled first (1^{st}) search space using a detected PLD from the retrograded second (2^{nd}) search space; and Step 4 (Reconstruction): Reconstructing peak detection according to PLD results from both the decoupled first (1^{st}) search space and the retrograded second (2^{nd}) search space to achieve reduced search complexity and improved detection accuracy.

This application claims the priority benefit of provisional patent application No. 63/765,434 titled “SPATIAL DECOUPLING METHOD FOR INITIAL SEARCHES IN GEOSYNCHRONOUS EARTH ORBIT SYSTEMS” filed on 28 Feb. 2025, the disclosure of which is incorporated by reference herein in its entirety.

### BACKGROUND OF THE INVENTION

### Field of the Invention

The present invention relates to the field of satellite communications and more particularly to a spatial decoupling method for initial searches in Geosynchronous Earth Orbit (GEO) systems.

### Description of the Related Art

Satellite communication involves the transmission of signals via electromagnetic beams between User Terminals (UTs) located on the Earth's surface and target satellites in orbit. The UT may include either fixed communication equipment or mobile communication equipment, with the latter installed on movable platforms such as ships and vehicles. To ensure accurate link transmission, each UT must align its beams with a corresponding target satellite.

The UT achieve accurate link transmission by using beam directivity to focus the transmitted signals toward the target satellite. When the UT is in motion, the mobile UT must search for the target satellite in the Geosynchronous Earth Orbit (GEO) and accordingly adjust its beam alignment.

### SUMMARY OF THE INVENTION

The main purpose of the present invention is to provide a spatial decoupling method for initial searches in Geosynchronous Earth Orbit (GEO) systems.

In order to achieve this purpose, the present invention employs the following technical solution:

The method comprises the following sequential steps:
Step 1 (Decoupling): Analyzing a spatial selectivity of a receive (Rx) beamforming output and performing spatial decoupling;
Step 2 (1^{st} PLD in 2^{nd} Search Space): Performing a (1^{st}) peak location detection (PLD) in a retrograded (2^{nd}) search space by using a given peak location (PL) guess obtained from a decoupled (1^{st}) search space;
Step 3 (2^{nd} PLD in 1^{st} Search Space): Performing a (2^{nd}) peak location detection (PLD) in the decoupled (1^{st}) search space based on a detection result obtained from the (1^{st}) peak location detection (PLD) performed in the retrograded (2^{nd}) search space; and
Step 4 (Reconstruction): Reconstructing a final peak location based on the peak location detection (PLD) results obtained from both the decoupled (1^{st}) search space and the retrograded (2^{nd}) search space.

The spatial decoupling method of the present invention offers several significant advantages. It effectively reduces search complexity, improves search efficiency, enhances the accuracy of peak location detection, and prevents power dead-zone issues. The method is particularly suitable for dynamic communication scenarios, such as mobile user terminals operating in Geosynchronous Earth Orbit (GEO) systems.

### BRIEF DESCRIPTION OF THE DRAWINGS

FIG. 1 shows an estimate of mechanical antenna orientation in a three-dimensional (3D) search space.

FIG. 2 shows the definition of the antenna orientation in the three-dimensional (3D) space.

FIG. 3 shows a search candidate set within a given search space.

FIG. 4 shows a spatial decoupling mechanism of the present invention.

FIG. 5 shows a detection mechanism of the multi-stage peak location detection (MSPLD) of the present invention.

FIG. 6 shows a beamforming output power profile along a slant (γ) axis.

FIG. 7 shows an angular hopping process of the present invention.

FIG. 8 shows a spatial decoupling for achieving dimensionality reduction of the search space.

FIG. 9 shows a block diagram of the peak location detection mechanism of the present invention.

FIG. 10 shows a beamforming output power profile along a bearing (α) axis.

FIG. 11 shows a beamforming output power profile along a down-tilt (8) axis.

FIG. 12 shows a beamforming output power profile along aslant (γ) axis.

FIG. 13 shows an example of spatial decoupling into two search spaces.

FIG. 14 shows an example of spatial decoupling into two search spaces when spatial variation along a certain direction is nearly constant.

FIG. 15 shows another example of spatial decoupling into two search spaces when spatial variation along a certain direction is nearly constant.

FIG. 16 shows a retrograded search space decoupled from a three-dimensional (3D) full search space.

FIG. 17 shows a decoupled search space decoupled from the three-dimensional (3D) full search space.

FIG. 18 shows an example of spatial decoupling according to the present invention.

FIG. 19 shows another example of spatial decoupling according to the present invention.

FIG. 20 shows a two-dimensional (2D) beamforming output power distribution between the bearing (α) and down-tile (β) axes for an N_{y}×N_{z}=32×32 uniform linear array.

FIG. 21 shows a two-dimensional (2D) beamforming output power distribution between the bearing (α) and down-tile (β) axes for an N_{y}×N_{z}=32×2 uniform linear array.

FIG. 22 shows a two-dimensional (2D) beamforming output power distribution between the bearing (α) and down-tile (β) axes for an N_{y}×N_{z}=2×32 uniform linear array.

FIG. 23 shows an example of a peak location detection (PLD) based on two-dimensional (2D) beamforming output power between the bearing (α) and down-tile (β) axes.

FIG. 24 shows an example of a peak location detection (PLD) based on two-dimensional (2D) beamforming output power between the bearing (α) and slant (γ) axes, in which the peak cannot be identified.

FIG. 25 shows an example of a peak location detection (PLD) based on two-dimensional (2D) beamforming output power between the down-tilt (β) and slant (γ) axes, in which the peak cannot be identified.

FIG. 26 shows an example of a peak location detection (PLD) based on two-dimensional (2D) beamforming output power between the bearing (α) and down-tile (β) axes, in which the peak location remains unchanged.

FIG. 27 shows an example of a peak location detection (PLD) based on two-dimensional (2D) beamforming output power between the bearing (α) and slant (γ) axes, in which the peak location drifts.

FIG. 28 shows an example of a peak location detection (PLD) based on two-dimensional (2D) beamforming output power between the down-tilt (β) and slant (γ) axes, in which the peak location drifts.

FIG. 29 shows an example of a peak location detection (PLD) based on two-dimensional (2D) beamforming output power between the bearing (α) and down-tile (β) axes, in which the peak location remains unchanged and the power slightly decreases.

FIG. 30 shows an example of a peak location detection (PLD) based on two-dimensional (2D) beamforming output power between the bearing (α) and slant (γ) axes, in which the peak location drifts.

FIG. 31 shows an example of a peak location detection (PLD) based on two-dimensional (2D) beamforming output power between the down-tilt (β) and slant (γ) axes, in which the peak location drifts.

FIG. 32 shows an example of a beamforming output power profile along the bearing (α) axis.

FIG. 33 shows an example of a beamforming output power profile along the down-tilt (β) axis.

FIG. 34 shows an example of a beamforming output power profile along the slant (γ) axis.

FIG. 35 shows a random guess process for addressing a power dead-zone issue.

FIG. 36 shows an illustration of an array index mapping diagram.

### DETAILED DESCRIPTION OF THE PREFERRED EMBODIMENTS

The accompanying drawings illustrate embodiments of a spatial decoupling method for initial searches in Geosynchronous Earth Orbit (GEO) systems in accordance with the present invention. These drawings are provided solely for illustrative purposes and are not intended to limit the scope of the invention.

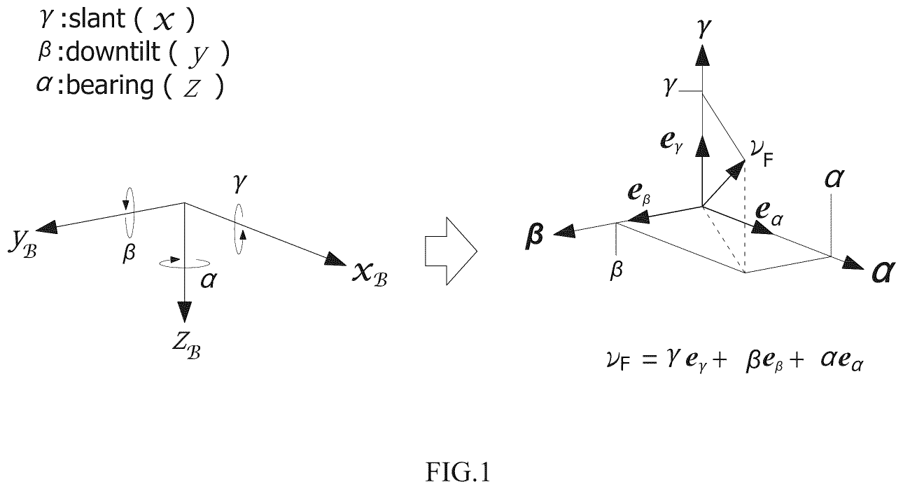

An optimal search for a three-dimensional (3D) joint space through a full-angle/global search corresponds to three-dimensional beam acquisition, which is a brute-force (exhaustive) blind search (scanning) mechanism. This method can probe one axis at a time or alternate between the three axes. It is a simple and low-cost approach; however, it is time-consuming. The performance of this brute-force mechanism depends on the step size or the Signal-to-Noise Ratio (SNR), and it requires no prior information. A two-stage strategy for a uniform exhaustive search involves using a fixed and relatively large step-size for large-scale probing in a first stage, followed by small-scale probing in a second stage. The second stage uses a fixed and relatively small step-size around the search points determined in the first stage. The search stop criterion is met when the pointing error is within a 3 dB beamwidth, thereby achieving the minimum link level required for alignment (e.g., for control signaling), such that: Pᵣₓ≥Pₘᵢₙ≈P_{3dB}. As shown in FIG. 1, the issue with the brute-force mechanism (i.e., exhaustive linear or uniform search) lies in an exhaustive peak location detection (PLD) of a receive (Rx) beamforming (BF) output. The objective function is the receive (Rx) beamforming output power, which is a function of the antenna direction (i.e., controlled by (γ,β,α)), and is represented as a triple-variable function. The goal is to determine the antenna direction (γ,β,α) that maximizes the receive (Rx) beamforming output power g. A peak location (PL) in the joint/full three-dimensional search space S_{F}, which is spanned by the three-dimensional orthonormal standard bases (e_{γ},e_{β},e_{α}), can be estimated by the corresponding (γ,β,α) obtained from measurements of a joint objective function gr in the joint/full three-dimensional (3D) search space, where:

$${𝒮}_{F} , {g}_{F} ≡ {g}_{γ β α} = {f}_{γ β α} ( γ , β , α ) .$$

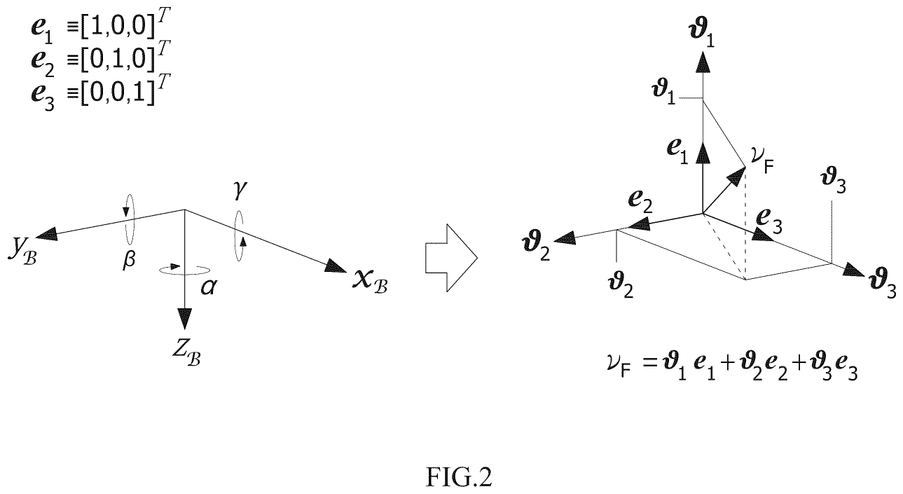

As shown in FIG. 2, a uniform peak location detection (PLD) is performed across all possible search candidates (set) VE in the joint/full three-dimensional (3D) search space [symbol] _{F}. The term ‘uniform’ in this context refers to a uniformly distributed set of search candidates defined by a specified start position and step-size. The joint/full three-dimensional (3D) search space [symbol] _{F} is mathematically expressed as:

$${𝒮}_{F} ≡ Span \{ {e}_{1} , {e}_{2} , {e}_{3} \} = \{ {ϑ}_{1} {e}_{1} + {ϑ}_{2} {e}_{2} + {ϑ}_{3} {e}_{3} \vert {ϑ}_{i} ∈ ℝ \} ∈ {ℝ}^{3} ,$$

$$where :$$

$${e}_{1} ≡ {[ 1 , 0 , 0 ]}^{T} , {e}_{2} ≡ {[ 0 , 1 , 0 ]}^{T} , {e}_{3} ≡ {[ 0 , 0 , 1 ]}^{T} ,$$

[symbol] _{F} represents the joint/full (3D, D_{F}=3) search space,
eᵢ∈ [symbol] ³ denotes an i^{th} orthonormal basis (specifying the i^{th} search direction ϑᵢ) in [symbol] _{F}, and
ϑᵢ represents a coefficient of the i^{th} standard basis (specifying the i^{th} search position).

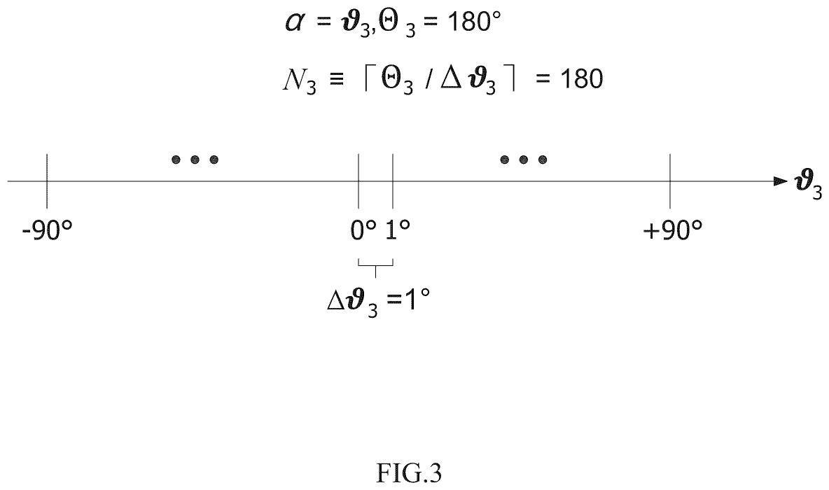

As shown in FIG. 3, a uniform (linear) search is defined as follows:

$${V}_{F} ≡ \{ \tilde{ϑ} \} ∈ {ℝ}^{3} ,$$

where V_{F} represents the uniform search set containing total N_{F} possible candidates {\tilde{ϑ}}_{L}, l=1, . . . , N_{F}.

Each candidate is expressed as:

$${\{ \tilde{ϑ} \}}_{l} ≡ {[ {\{ {\tilde{ϑ}}_{1} \}}_{{l}_{1}} , {\{ {\tilde{ϑ}}_{2} \}}_{{l}_{2}} , {\{ {\tilde{ϑ}}_{3} \}}_{{l}_{3}} ]}^{T} ∈ {ℝ}^{3} ,$$

where l=map ((j₁,j₂,j₃))=1, . . . , N_{F}.

For the i^{th} search direction ϑᵢ:

$${V}_{i} ≡ \{ {\tilde{ϑ}}_{i} \} ∈ {ℝ}^{1} ,$$

where Vᵢ is the uniform search set containing Nᵢ candidates {\tilde{ϑ}ᵢ}_{L}_{ᵢ}∈ [symbol] ¹, lᵢ=1, . . . , Nᵢ, along the i^{th} search direction ϑᵢ.

### Search Parameters:

Search range: Along the i^{th} search direction ϑᵢ, the range is determined by the Field of View (FoV) Θᵢ:

$${Θ}_{i , min} \leq {ϑ}_{i} , {\tilde{ϑ}}_{i} \leq {Θ}_{i , max} , {Θ}_{i} ≡ {Θ}_{i , max} - {Θ}_{i , min} .$$

Step-size: The constant step size (i.e., search spacing) along the i^{th} search direction ϑᵢ is denoted as Δϑᵢ.
Number of candidates: The number of candidates (i.e., size of search set) Nᵢ along the i^{th} search direction ϑᵢ is given by:

$${N}_{i} ≡ L ( {V}_{i} ) = L ( \{ {\tilde{ϑ}}_{i} \} ) = ⌈ \frac{{Θ}_{i}}{{Δϑ}_{i}} ⌉ .$$

The number of overall candidates (i.e., the overall search number) N_{C} in the joint/full three-dimensional (3D) search space [symbol] _{F} is given by:

$${N}_{C} ≡ L ( {V}_{F} ) = L ( \{ \tilde{ϑ} \} ) -= {\prod }_{i = 1}^{{D}_{F} = 3} {N}_{i} = {N}_{1} {N}_{2} {N}_{3} ,$$

EX: {\tilde{ϑ}}∈ [symbol] ², N₁=2, N₂=3, i=1, 2, N_{F}=N₁N₂=6

$$\{ \tilde{ϑ} \} = \{ {\underbrace{[ \begin{matrix}{\{ {ϑ}_{1} \}}_{1} \\ {\{ {ϑ}_{2} \}}_{1}\end{matrix} ]}}_{l = 1 : {\{ \tilde{ϑ} \}}_{1}} , {\underbrace{[ \begin{matrix}{\{ {ϑ}_{1} \}}_{1} \\ {\{ {ϑ}_{2} \}}_{2}\end{matrix} ]}}_{l = 2 : {\{ \tilde{ϑ} \}}_{2}} , {\underbrace{[ \begin{matrix}{\{ {ϑ}_{1} \}}_{1} \\ {\{ {ϑ}_{2} \}}_{3}\end{matrix} ]}}_{l = 3 : {\{ \tilde{ϑ} \}}_{3}} , {\underbrace{[ \begin{matrix}{\{ {ϑ}_{1} \}}_{2} \\ {\{ {ϑ}_{2} \}}_{1}\end{matrix} ]}}_{l = 4 : {\{ \tilde{ϑ} \}}_{4}} , {\underbrace{[ \begin{matrix}{\{ {ϑ}_{1} \}}_{2} \\ {\{ {ϑ}_{2} \}}_{2}\end{matrix} ]}}_{l = 5 : {\{ \tilde{ϑ} \}}_{5}} , {\underbrace{[ \begin{matrix}{\{ {ϑ}_{1} \}}_{2} \\ {\{ {ϑ}_{2} \}}_{3}\end{matrix} ]}}_{l = 6 : {\{ \tilde{ϑ} \}}_{6}} \}$$

The overall search number in the joint/full three-dimensional search space S_{F} is calculated as:

$${N}_{C} = {N}_{1} {N}_{2} {N}_{3}$$

EX-1: If Θ₁=180°, Θ₂=90°, Θ₃=360°, and Δϑ₁=Δϑ₂=Δϑ₃=1°, then N_{C}=180×90×360=5,832×10³.
EX-2: If Θ₁=180°, Θ₂=90°, Θ₃=360°, and Δϑ₁=Δϑ₂=Δϑ₃=3° (where the 3-dB beamwidth in bearing/down-tilt is approximately BW_{3dB}=3.16° for a 32-element array), then N_{C}=60×30×120=216×10³.

While the brute-force solution for mechanical antenna orientation mechanisms is conceptually simple and theoretically optimal, the substantial number of required searches results in significant computational time consumption and mechanical wear-and-tear issues.

A sub-optimal solution is therefore proposed by using a spatial decoupling technique to reduce the dimensionality of the search space. In general, K=2 separate search spaces can be constructed to decrease the number of searches. A multi-stage peak location detection (MSPLD) process (typically Q=2 stages are sufficient) using successively decreasing search step-size is further introduced to reduce computational complexity and accelerate decision-making. Additionally, an angular hopping process (typically P=2 hopping iterations) can be applied to avoid power dead zones during the peak location detection (PLD), thereby enhancing overall system performance.

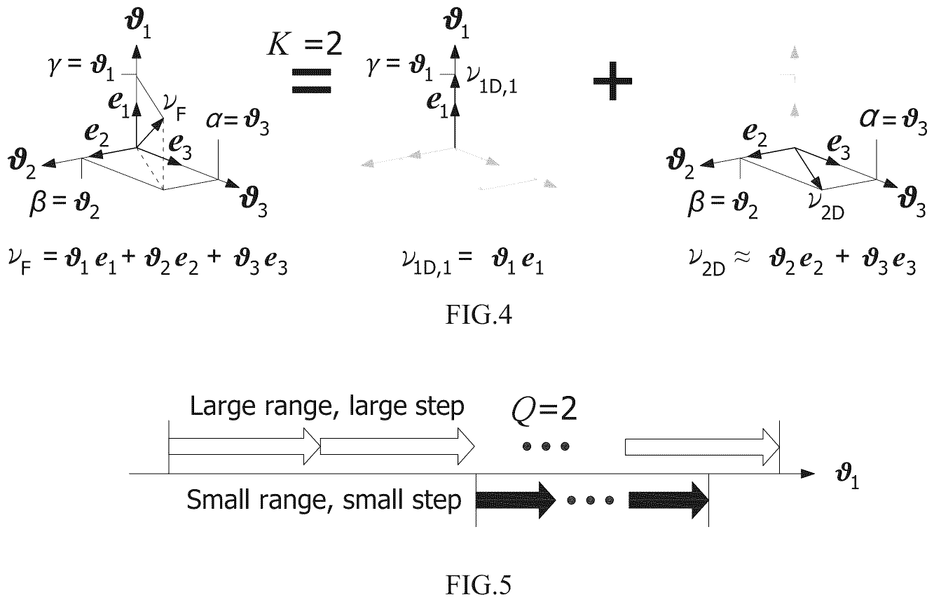

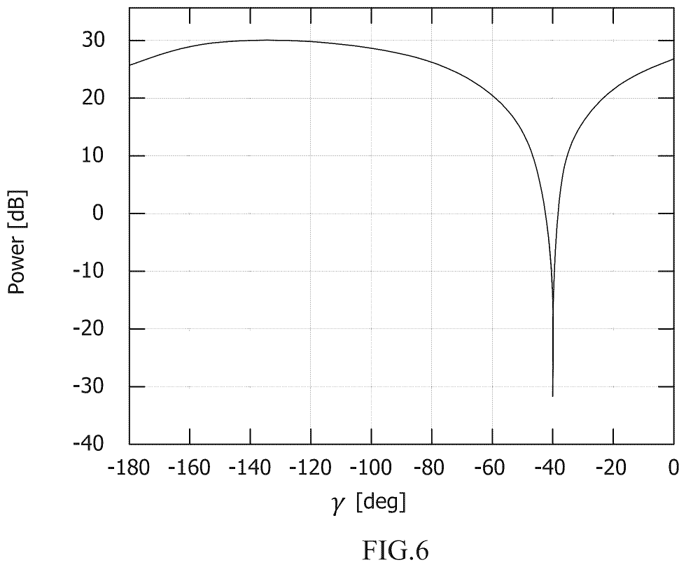

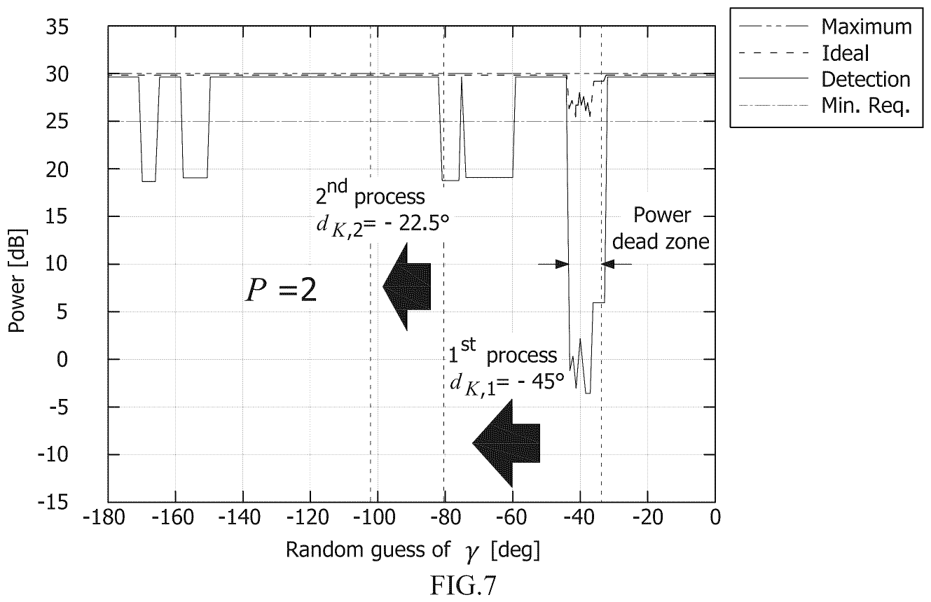

As shown in FIGS. 4 through 7, the proposed sub-optimal solution for the initial search in a Geosynchronous Earth Orbit (GEO) system during a cold-start phase includes the following key operations: (1) Spatial decoupling for reducing the dimensionality of the search space; (2) Multi-stage peak location detection (MSPLD) for accelerating processing time, and (3) Angular hopping of the peak location for avoiding the power dead-zone issues.

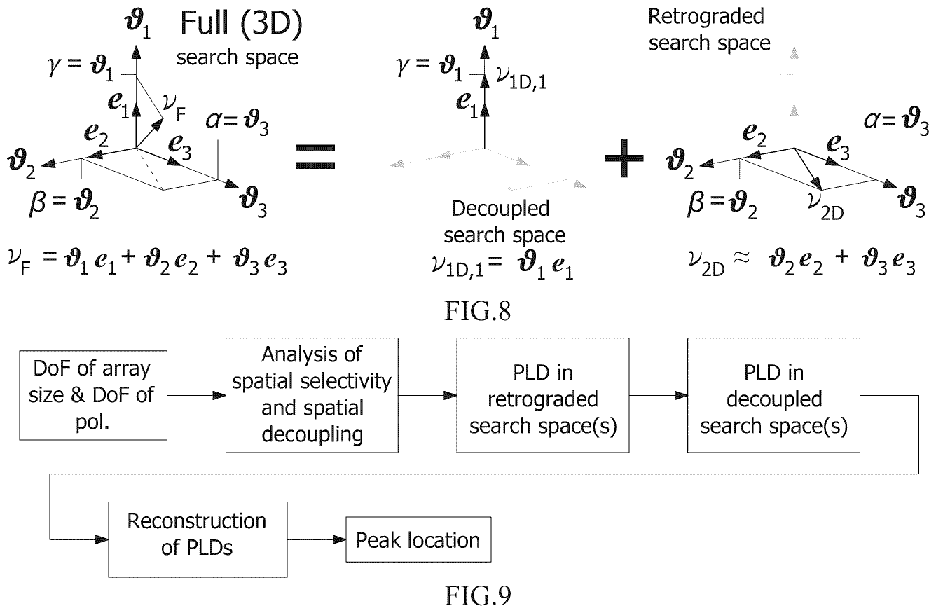

As shown in FIGS. 8 and 9, the spatial decoupling process for search space dimensionality reduction comprises the following steps:
Step 1 (Decoupling): Analyzing a spatial selectivity of the receive (Rx) beamforming output and performing spatial decoupling;
Step 2 (1^{st} PLD in 2^{nd} Search Space): Performing a peak location detection (PLD) in a retrograded search space by using a given peak location (PL) guess obtained from a decoupled search space;
Step 3 (2^{nd} PLD in 1^{st} Search Space): Performing a PLD in the decoupled search space based on a detection result obtained from the retrograded search space; and
Step 4 (Reconstruction): Reconstructing a peak detection using the peak location detection (PLD) results obtained from both the decoupled and retrograded search spaces.

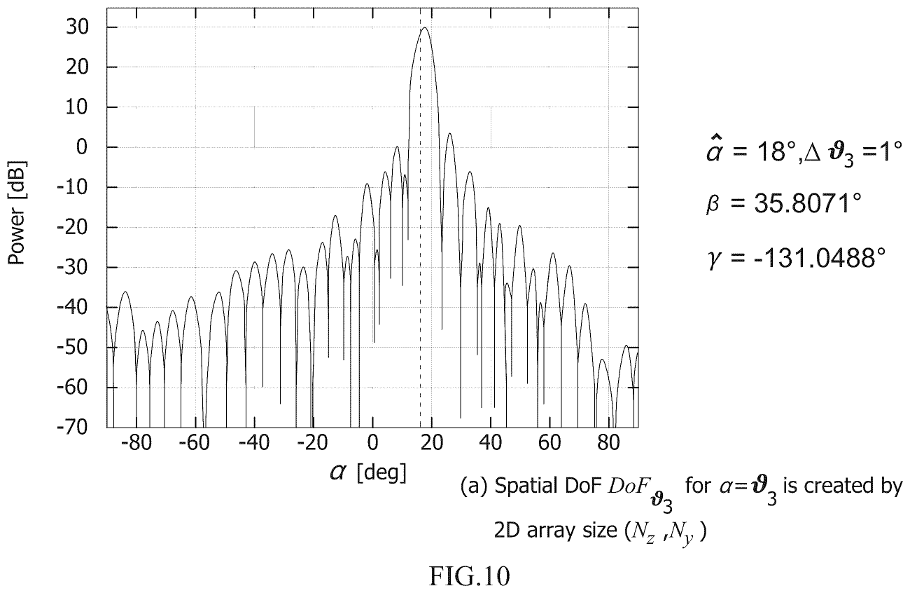

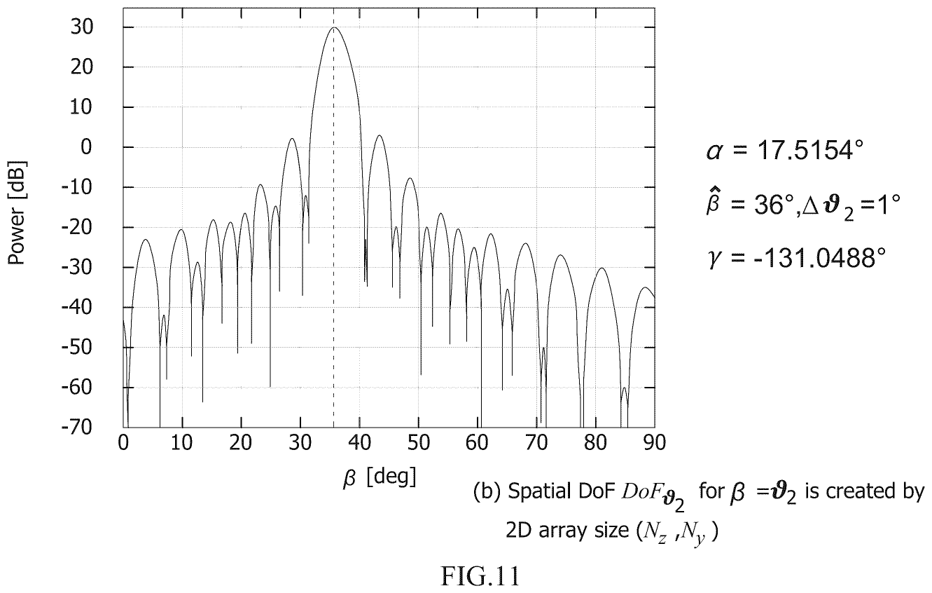

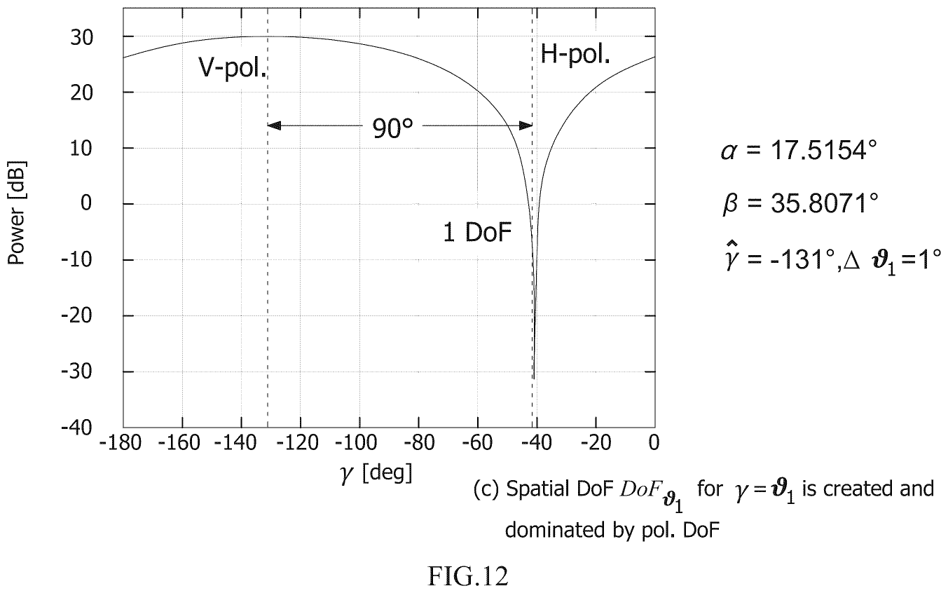

As shown in FIGS. 10 through 12, Step 1 involves analyzing the spatial selectivity of the beamforming output power and performing spatial decoupling, where the spatial selectivity analysis is performed based on a beam pattern over a continuous (mechanical) but not a discrete (electrical) angular scale. The spatial selectivity (i.e., the angular variation characteristics) is determined by spatial Degrees-of-Freedom (DoF), which are created by the antenna array size and polarization DoF. In FIG. 12, a very slow “angular variation” is observed along γ=ϑ₁ due to its lower degrees of freedom compared to that along α=ϑ₃ and β=ϑ₂.
Corollary 1: The joint/full three-dimensional (3D) search space S_{F} can be decoupled into more than one (i.e., K≥2) separate (i.e., near-independent) search spaces for peak location detection (PLD);
Corollary 2: When the spatial variation along an i^{th} direction ϑᵢ is almost constant, the corresponding search space Si can thus be decoupled from the joint/full three-dimensional (3D) space [symbol] _{F}, that is: g_{ϑ}_{ᵢ}=ƒ_{ϑ}_{ᵢ}(ϑᵢ)≈constant.

Corollary 3: A randomly estimate of ϑᵢ in ϑᵢ can be arbitrarily pre-specified as \hat{ϑ}ᵢ (and thus decoupled) without significantly changing the beamforming (BF) output power g_{ϑ}_{_{∀j≠i}} in other directions ϑⱼ (∀j≠i). The BF output power in these directions is defined as:

$${g}_{{ϑ}_{∀ j \neq i}} ≡ {f}_{{ϑ}_{∀ j \neq i}} ( {ϑ}_{∀ j \neq i} ) ,$$

where g_{ϑ}_{_{∀j≠i}} represents the receive (Rx) BF output power in the space spanned by eⱼ (∀j≠i). For example, in a two-dimensional space:

$${g}_{{ϑ}_{2} {ϑ}_{3}} = {f}_{{ϑ}_{2} {ϑ}_{3}} ( {ϑ}_{2} , {ϑ}_{3} ) .$$

Corollary 4: The main beam profile of g_{ϑ}_{_{∀j}} will be distributed linearly as a simple straight line along the i^{th} specific search direction ϑᵢ.

Corollary 5: In general, K=2 represents two separate search spaces: a retrograded space and a decoupled space.

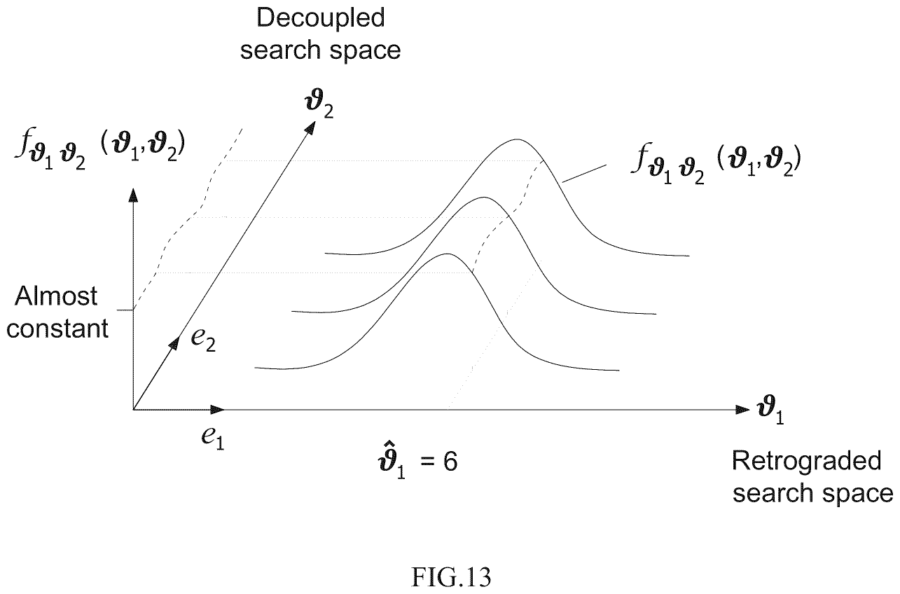

As shown in FIG. 13. Definition 1: Any one-dimensional (1D) search space (with relatively low spatial selectivity), that can be decoupled from the joint/full three-dimensional (3D) search space, is defined as the “decoupled” space, and the remaining degraded two-dimensional (2D) joint space obtained from the original joint/full three-dimensional (3D) search space is defined as the “retrograded” space.

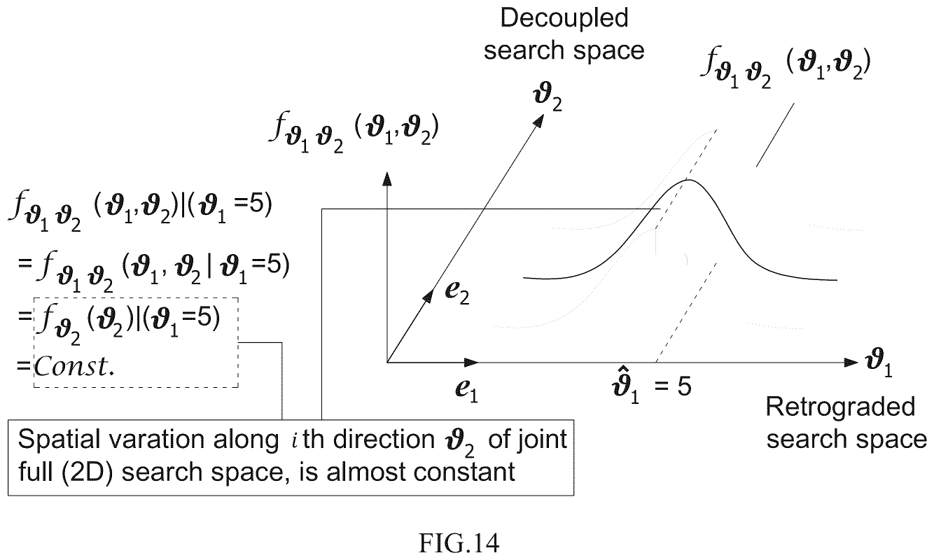

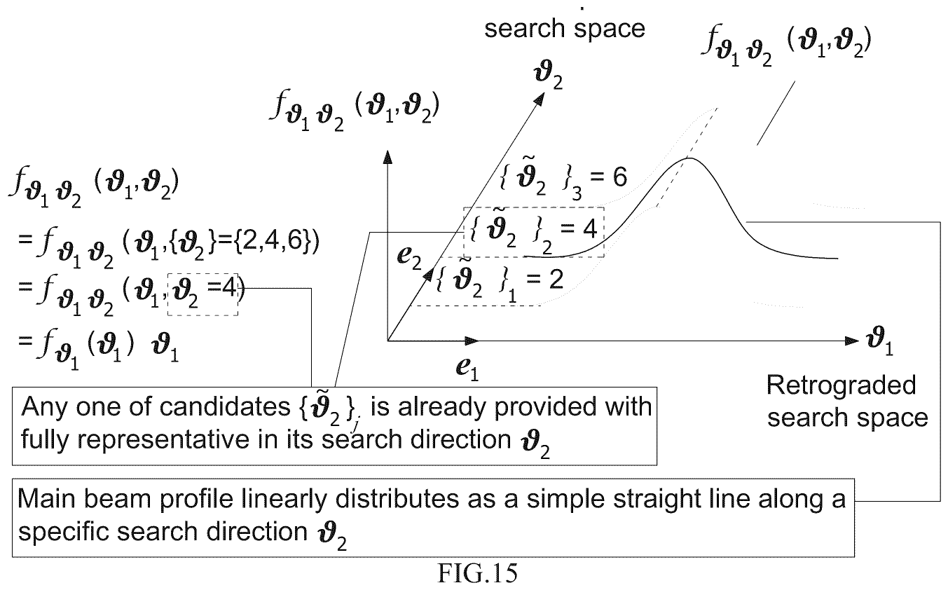

As shown in FIG. 14. Spatial Decoupling: At least one search space Si along an i^{th} direction ϑᵢ, spanned by a basis vector et, can be approximately decoupled from the joint/full three-dimensional (3D) search space [symbol] _{F}. This decoupled search space, denoted as [symbol] _{D,k}(= [symbol] ᵢ), is feasible for peak location detection (PLD) based on beamforming (BF) output power if the spatial variation of the beamforming (BF) output power along that direction ϑᵢ is sufficiently small.
Step 2: As shown in FIG. 15, the peak location detection (PLD) is performed in the retrograded search space. An equivalent retrograded receive (Rx) beamforming (BF) output power, g_{ϑ}_{_{∀j≠i}} can be obtained from the joint objective function g_{F} according to the aforementioned spatial decoupling. Because the variables ϑᵢ=\hat{ϑ}ᵢ in the joint objective function g_{F} can be arbitrarily pre-specified without causing significant changes to the joint objective function g_{F}, they can almost be discarded from the joint objective function g_{F}. The function g_{(ϑ}_{_{(∀j≠i)}}₎, which includes Dₖ variables ϑ_{(∀j≠i)}, is thus a sub-function of the joint objective function g_{F}, and Dₖ≤D_{F}.

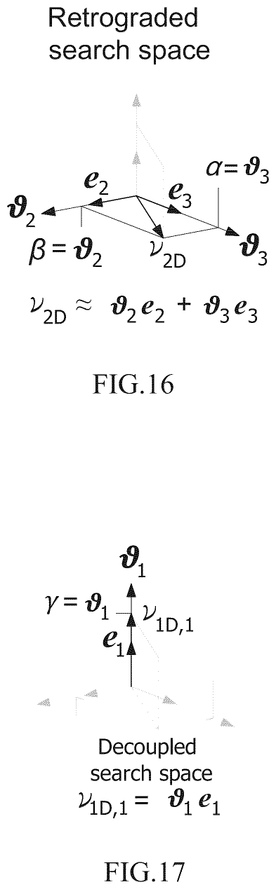

As shown in FIG. 16, if the search space [symbol] ᵢ along the i^{th} direction ϑᵢ, spanned by the basis vector eᵢ, can be discarded or disjointed from the joint/full search space [symbol] _{F}, a uniform search set V_{D,k}≡{\tilde{ϑ}ₖ}∈ [symbol] ^{D}^{ₖ} is constructed. This retrograded search set is retrograded from the joint/full three-dimensional (3D) search set V_{F}={\tilde{ϑ}}∈ [symbol] ^{D}^{_{F}}. Each l_{D,k}^{th} candidate in the retrograded search set is represented as:

$${\{ {\tilde{ϑ}}_{k} \}}_{{l}_{D , k}} = {[ {\{ {\tilde{ϑ}}_{k , 1} \}}_{{l}_{k , 1}} , … , {\{ {\tilde{ϑ}}_{k , {D}_{k}} \}}_{{l}_{k , {D}_{k}}} ]}^{T} ∈ {ℝ}^{{D}_{k}} ,$$

$${l}_{D , k} = 1 , … , {N}_{D , k} , {l}_{k , {i}_{k}} = 1 , … , {N}_{k , {i}_{k}} .$$

Here, the mapping between indices is given by:

$${l}_{D , k} = map ( ( {l}_{k , 1} , … , {l}_{k , {D}_{k}} ) ) , ( {l}_{k , 1} , … , {l}_{k , {D}_{k}} ) = map ( {l}_{D , k} ) .$$

In the retrograded search space [symbol] _{D,k} [symbol] ^{D}^{ₖ}, the number of candidates N_{D,k} within the uniform search set V_{D,k}≡{\tilde{ϑ}ₖ}∈ [symbol] ^{D}^{ₖ} is given by:

$${N}_{D , k} ≡ L ( {V}_{D , k} ) = L ( \{ {ϑ}_{k} \} ) = {\prod }_{{i}_{k} = 1}^{{D}_{k}} {N}_{k , {i}_{k}} , {N}_{k , {i}_{k}} = ⌈ {Θ}_{k , {i}_{k}} / {Δϑ}_{k , {i}_{k}} ⌉ ∈ \{ {N}_{∀ j \neq i} \} ,$$

where, N_{k,i}_{ₖ} represents the number of candidates along the i^{th} search direction in the k^{th} retrograded search space [symbol] _{D,k}∈ [symbol] ^{D}^{ₖ}.

The estimation of the peak location is then conducted within the uniform search candidate set V_{D,k}≡{\tilde{ϑ}ₖ}∈ [symbol] ^{D}^{ₖ} in the search space [symbol] _{D,k}∈ [symbol] ^{D}^{ₖ}.

As shown in FIG. 17, Step 3: The peak location detection (PLD) is performed in the decoupled search space, which is characterized by an almost flat angular profile. The peak location detection (PLD) is complete using a lowest-order peak location detection (PLD) procedure, where an arbitrarily specified temporary estimate is assigned along the search direction to facilitate dimensionality reduction through spatial decoupling. Although a temporary, randomly selected estimate may expedite the decoupling process, it may not provide optimal performance. Therefore, after spatial decoupling, the accurate peak location must be re-estimated to improve performance. The decoupled one-dimensional (1D) search space is defined as [symbol] _{D,k}(= [symbol] ᵢ), which is spanned by

$${e}_{{i}_{k} = 1}^{′}$$

in the i^{th} direction:

$${𝒮}_{D , k} = Span \{ {e}_{{i}_{k}}^{′} \} = Span \{ {e}_{1}^{′} \vert {ϑ}_{1}^{′} ∈ ℝ \} = Span \{ {ϑ}_{i} {e}_{i} \vert {ϑ}_{i} ∈ ℝ \} = Span \{ {e}_{i} \} = {𝒮}_{i} ∈ {ℝ}^{1} .$$

In the decoupled one-dimensional search space [symbol] _{D,k}∈ [symbol] ¹, the number of candidates N_{D,k} within the uniform search set V_{D,k}≡{\tilde{ϑ}ₖ}={\tilde{ϑ}ₖ}∈ [symbol] ¹ is determined by:
N_{D,k}≡L(V_{D,k})=L({\tilde{ϑ}ₖ})=N_{K,i}_{ₖ}₌₁, N_{K,1}=N_{k,i}=┌Θ_{k,i}/Δϑ_{k,i}┐. The peak locations are then re-estimated within the uniform search candidate set V_{D,k}={\tilde{ϑ}ₖ}∈ [symbol] ¹ in the decoupled search direction ϑᵢ.

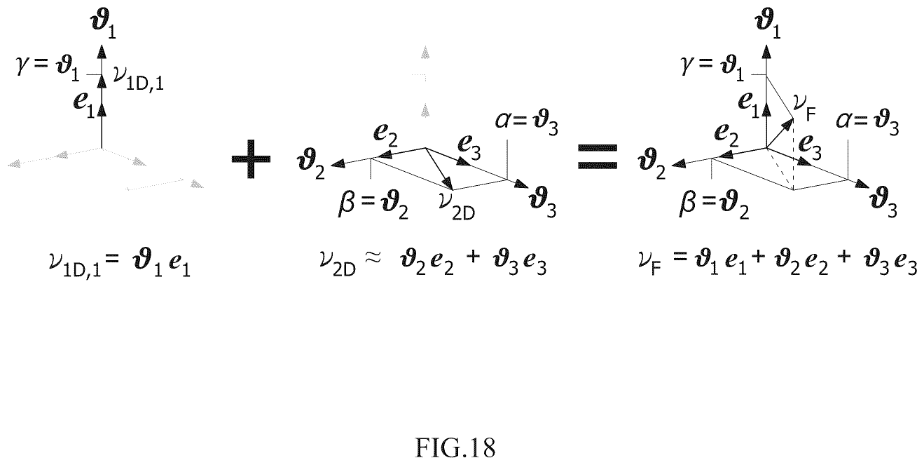

As shown in FIG. 18, Step 4: The integration of peak estimates from the retrograded search space [symbol] _{D,k}∈ [symbol] ^{D}^{ₖ} and the decoupled search space [symbol] _{D,k}∈ [symbol] ¹ using the spatial decoupling technology allows for the reconstruction of the joint/full three-dimensional (3D) peak location, represented as (\hat{γ},\hat{β},\hat{α})=(\hat{ϑ}₁,\hat{ϑ}₂,\hat{ϑ}₃).

The total number of the peak location detection (PLD) searches is calculated as:

$${N}_{C} = {\sum }_{k = 1}^{K} {N}_{D , k} = {\sum }_{k = 1}^{K} {\underbrace{{\prod }_{{i}_{k} = 1}^{{D}_{k}} {N}_{k , {i}_{k}}}}_{{N}_{D , k}} = {\sum }_{k = 1}^{K} {\underbrace{{\prod }_{{i}_{k} = 1}^{{D}_{k}} ⌈ {Θ}_{k , {i}_{k}} / {Δϑ}_{k , {i}_{k}} ⌉}}_{{N}_{D , k}}$$

If the joint/full three-dimensional (3D) search space S_{F} is decomposed into a two-dimensional (2D) joint search space [symbol] _{D,1} spanned by the basis vectors e₂ and e₃, and a one-dimensional (1D) search space [symbol] _{D,2} spanned by the basis vector e₁ based on the peak location detection (PLD), the overall search number for all separate search spaces can be determined as follows:
1. For the first separate search space [symbol] _{D,1} (k=1): N_{D,1}=N_{1,1}N_{1,2}.
2. For the second separate search space [symbol] _{D,2} (k=2): N_{D,2}=N_{2,1}.
EX-3: Using a conventional method for the joint/full three-dimensional (3D) search space S_{F} with the following parameters Θ₁=180°, Θ₂=90°, Θ₃=360°, and Δϑ₁=Δϑ₂=Δϑ₃=3°, the total number of computations is N_{C}=61×31×121=228,811.
EX-4: Considering the detection based on dimensionality reduction by spatial decoupling to decompose the joint/full three-dimensional (3D) search space S_{F} into a two-dimensional (2D) joint search space S_{(D,1)} spanned by e₂ and e₃, and a one-dimensional (1D) search space S_{(D,2)} spanned by e₁, with the following parameters ϑ₁=180°, Θ₂=90°, Θ₃=180°, and Δϑ₁=Δϑ₂=Δϑ₃=3°, the resulting number of computations is N_{C}=61× 31+121=2,012, and the computational ratio is

$$R = \frac{{N}_{C , SD}}{{N}_{C , Opt}} = \frac{2 , 012}{228 , 811} < 1 \% .$$

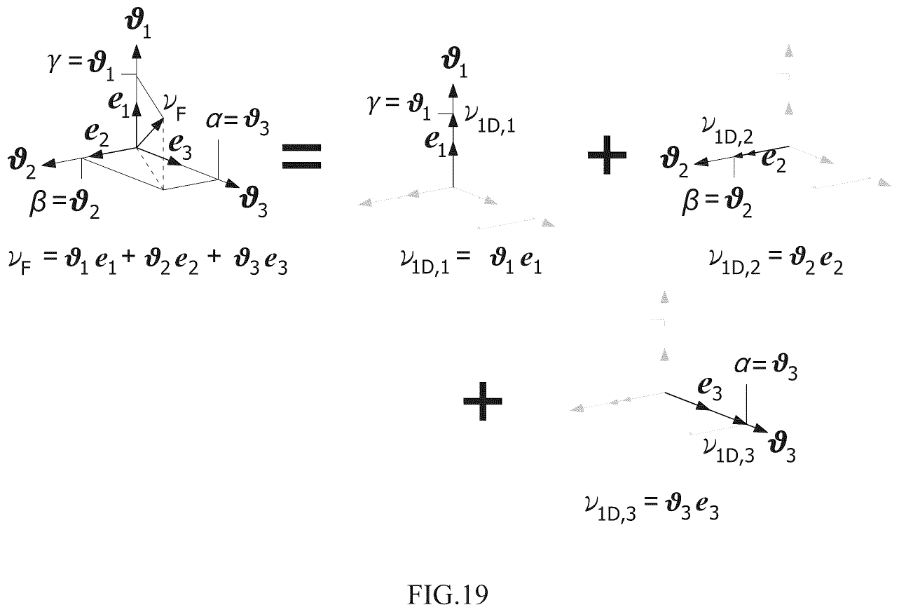

The following section discusses implementation issues related to spatial decoupling in initial searches. As shown in FIG. 19, the first question is whether the joint/full three-dimensional (3D) search space S_{F} can be fully decoupled into K=3 one-dimensional (1D) separate and independent search spaces. The answer is negative. In general, the maximum number of separatable search spaces is K=2.

If the joint/full three-dimensional (3D) search space [symbol] _{F} were fully decoupled into K=3 one-dimensional (1D) separate and independent search spaces (directions) [symbol] _{D,k}= [symbol] ᵢ=ϑᵢ∈ [symbol] ¹ (where k=i=1, 2, 3), then the detection process would be: Individually detecting a peak location within each uniform search candidate set V_{D,i}={ϑᵢ}∈ [symbol] ¹, using given temporary random guesses or pre-specified estimates ϑⱼ=\hat{ϑ}ⱼ (∀j≠i) for the other search directions ϑⱼ in the decoupled search direction ϑᵢ, and reconstructing a final joint three-dimensional (3D) peak location by combining the three individual one-dimensional (1D) detections.

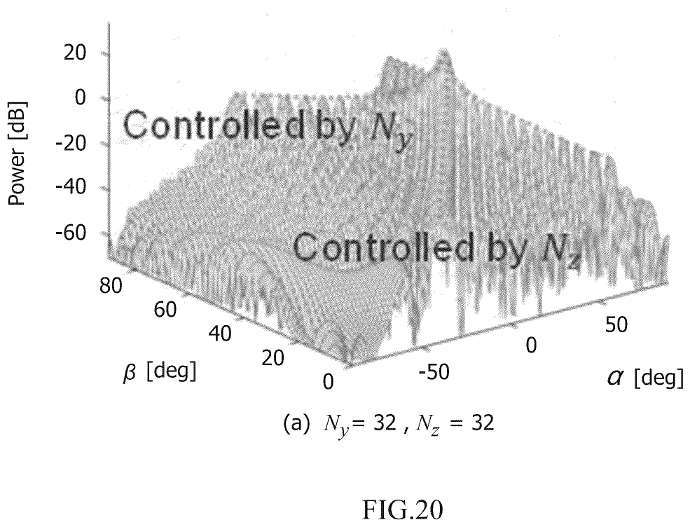

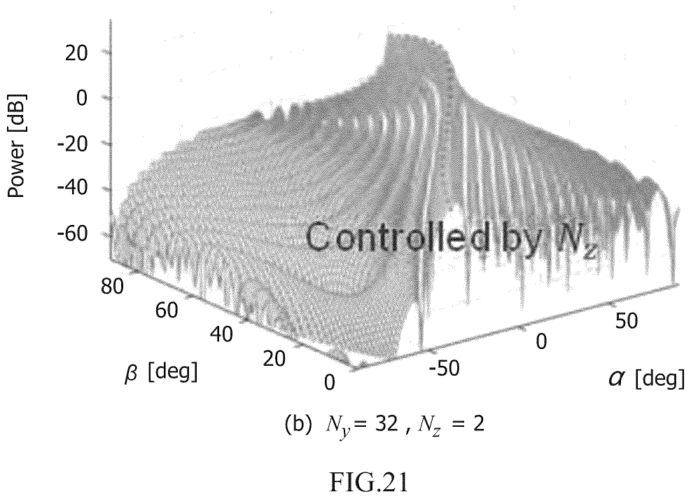

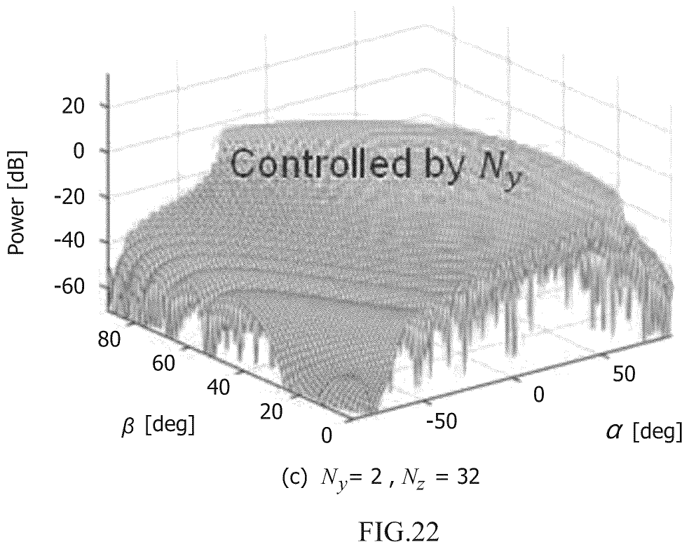

However, as shown in FIGS. 20 through 22, for a Geosynchronous Orbit (GSO) system, full decoupling is impossible. In fact, the joint/full three-dimensional (3D) search space [symbol] _{F} can only be decoupled into two separate search spaces: a two-dimensional (2D) joint search space [symbol] _{D,1} spanned by e₂ and e₃, and a one-dimensional (1D) search space [symbol] _{D,2} spanned by e₁. The search space [symbol] _{D,1}, spanned by e₂ and e₃, cannot be further and fully decoupled into two individual and independent one-dimensional (1D) search spaces, each spanned by e₂ and e₃, respectively. This holds true even if the array size along one of the axes is significantly smaller than that along the other. As FIGS. 21 and 22 shows, the main beam profile does not linearly distribute as a simple straight line along any specific search basis.

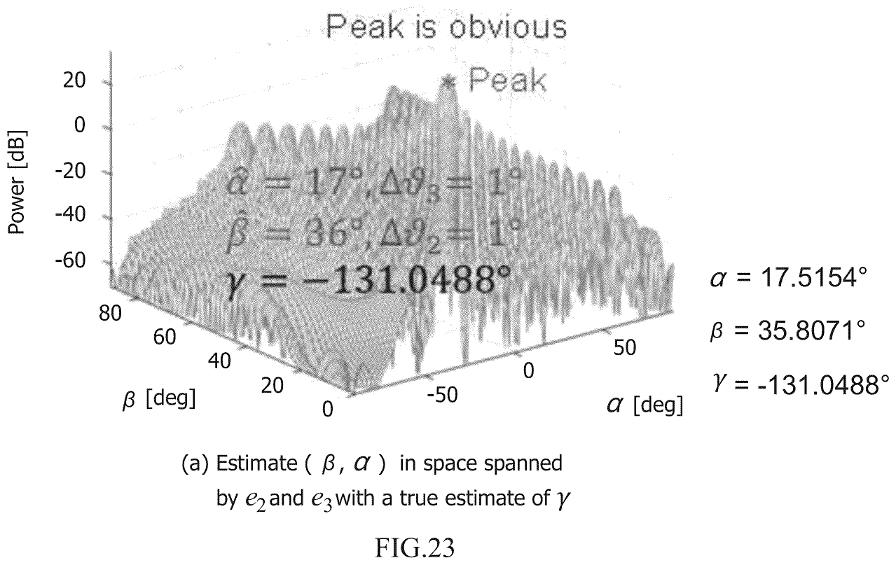

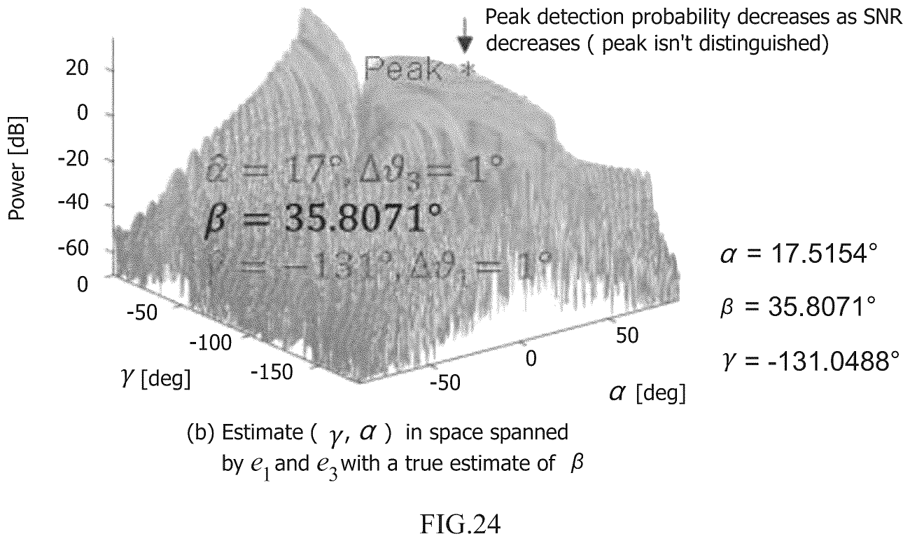

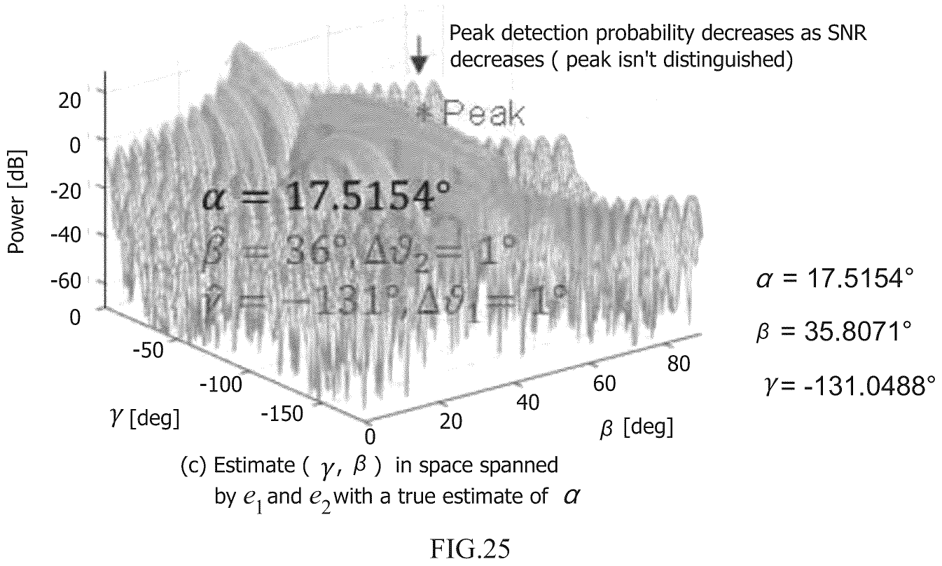

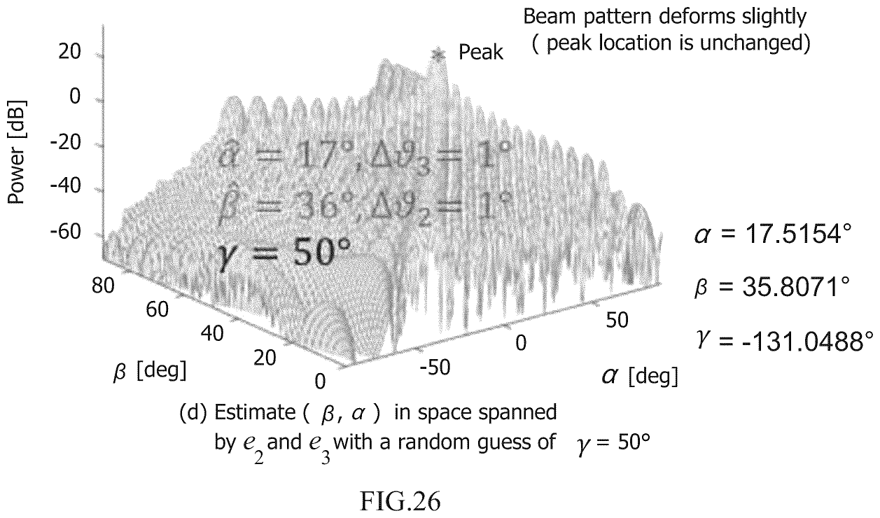

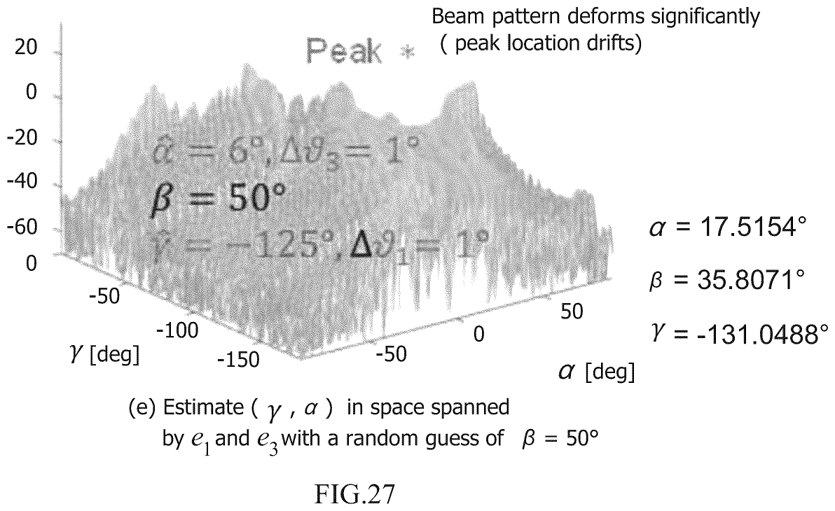

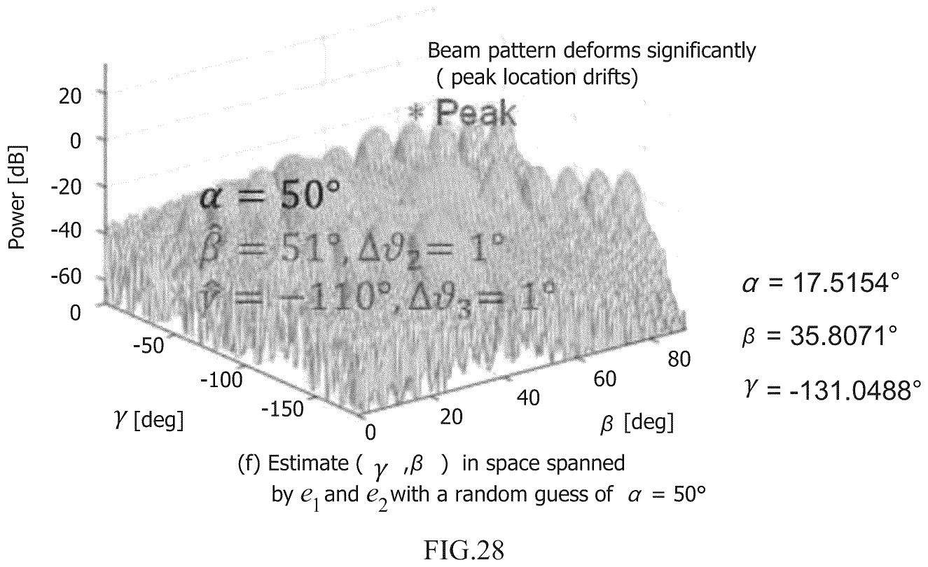

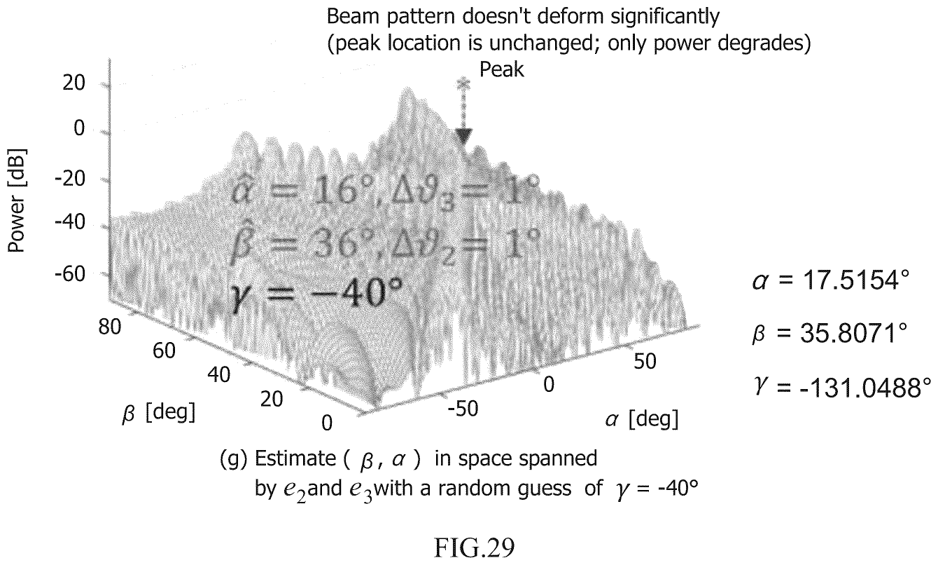

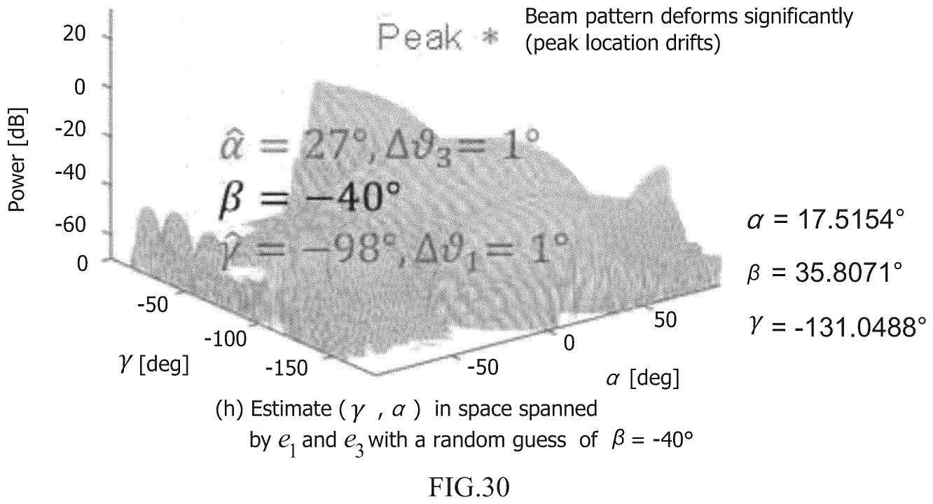

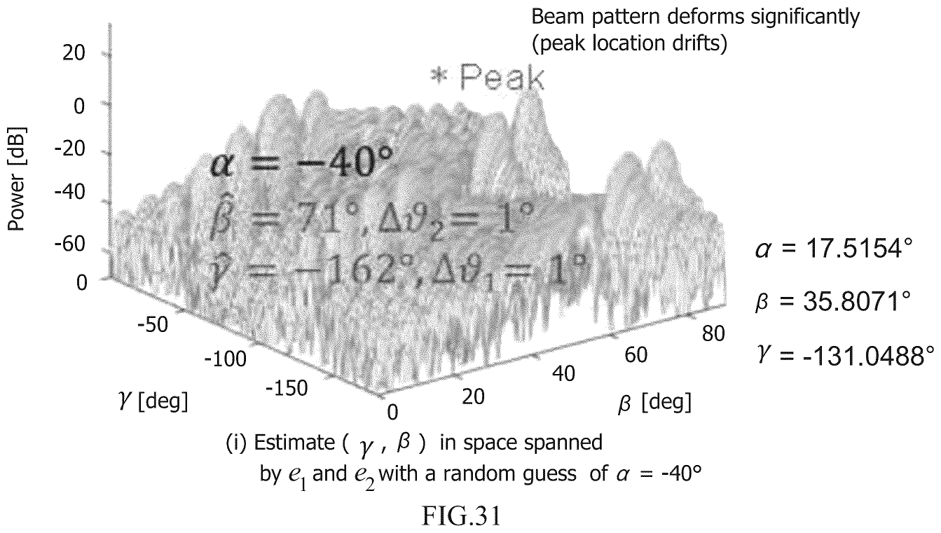

The following examples are given to illustrate the implementation issues on spatial decoupling for retrograded joint two-dimensional (2D) search space and decoupled one-dimensional (1D) search space.
EX-5: As shown in FIG. 23, when the joint/full three-dimensional (3D) search space [symbol] _{F} is decoupled into two separate spaces and (β,α) are estimated with a true estimate of γ=−131.0488°, a peak is observed.
EX-6: As shown in FIG. 24, when decoupling the joint/full three-dimensional (3D) search space S_{F} into two separate spaces and estimating (γ,α) with a true estimate of β=35.8071°, the peak detection probability decreases as the Signal-to-Noise Ratio (SNR) decreases, causing the peak to become indistinct.
EX-7: As shown in FIG. 25, when decoupling the joint/full three-dimensional (3D) search space [symbol] _{F} into two separate spaces and estimating (γ,β) with a true estimate of α=17.5154°, the peak detection probability decreases with decreasing SNR, resulting in an indistinguishable peak.
EX-8: As shown in FIG. 26, when decoupling the joint/full three-dimensional (3D) search space [symbol] _{F} into two separate spaces and estimating (β,α) with a random guess γ=50°, the beam pattern slightly deforms compared with that in EX-5, but the peak location remains unchanged.
EX-9: As shown in FIG. 27, when decoupling the joint/full three-dimensional (3D) search space [symbol] _{F} into two separate spaces and estimating (γ,α) with a random guess β=50°, the beam pattern significantly deforms compared with that in EX-6, causing the peak location to drift.
EX-10: As shown in FIG. 28, when decoupling the joint/full three-dimensional (3D) search space [symbol] _{F} into two separate spaces and estimating (γ,β) with a random guess α=50°, the beam pattern significantly deforms compared with that in EX-7, and the peak location drifts accordingly.
EX-11: As shown in FIG. 29, when decoupling the joint/full three-dimensional (3D) search space [symbol] _{F} into two separate spaces and estimating (β,α) with a random guess γ=−40°, the beam pattern shows no significant deform compared with that in EX-5. Only a power reduction occurs, and the peak location remains unchanged.
EX-12: As shown in FIG. 30, when decoupling the joint/full three-dimensional (3D) search space [symbol] _{F} into two separate spaces and estimating (γ,α) with a random guess β=−40° the beam pattern significantly deforms compared with that in EX-6, causing the peak location to drift.
EX-13: As shown in FIG. 31, when decoupling the joint/full three-dimensional (3D) search space [symbol] _{F} into two separate spaces and estimating (γ,β) with a random guess α=−40°, the beam pattern significantly deforms compared with that in EX-7, and the peak location drifts.

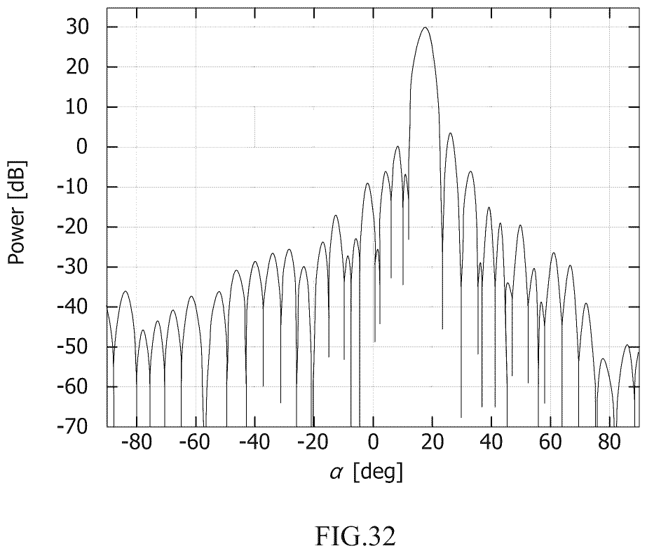

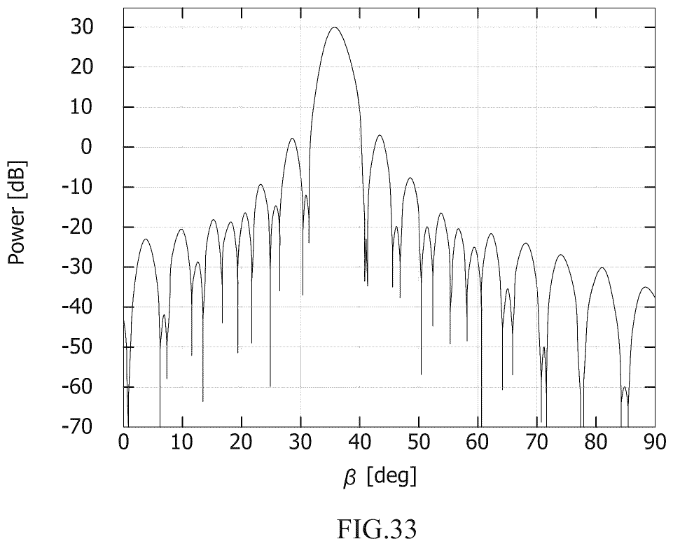

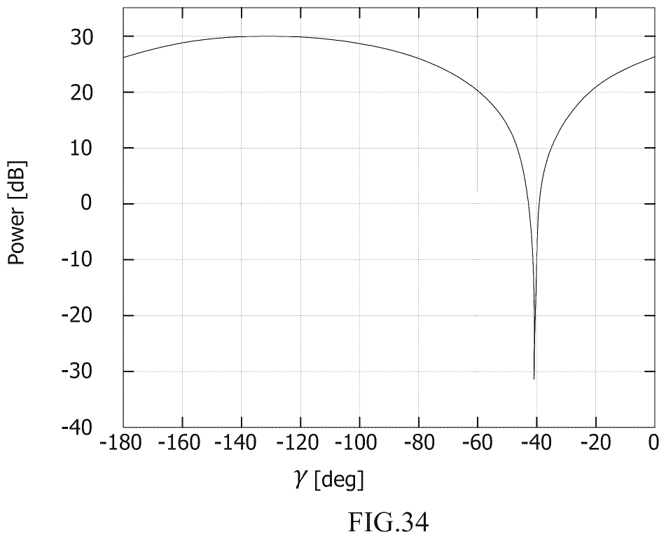

As shown in FIGS. 32 through 34, the detection order of the peak location detection (PLD) among the separate search spaces is determined by the spatial selectivity (i.e., the spatial Degrees-of-Freedom (DoF)) of the receive (Rx) beamforming (BF) output power within the corresponding space. Specifically, search spaces with a higher spatial selectivity are assigned higher detection priority, and their peak location detection (PLD) should be performed first. For a Geosynchronous Orbit (GSO) system, the detection of γ=ϑ₁ along the search directions ϑ₁ (or within the search space [symbol] ₁) generally has the lowest detection priority. This is because the Degrees-of-Freedom satisfy DoF_{ϑ}_{₁}<<{DoF_{ϑ}_{₂},DoF_{ϑ}_{₃}}. For example, in a GSO scenario, DoF_{ϑ}_{₁}=2, while DoF_{ϑ}_{₂}=DoF_{ϑ}_{₃}=32.

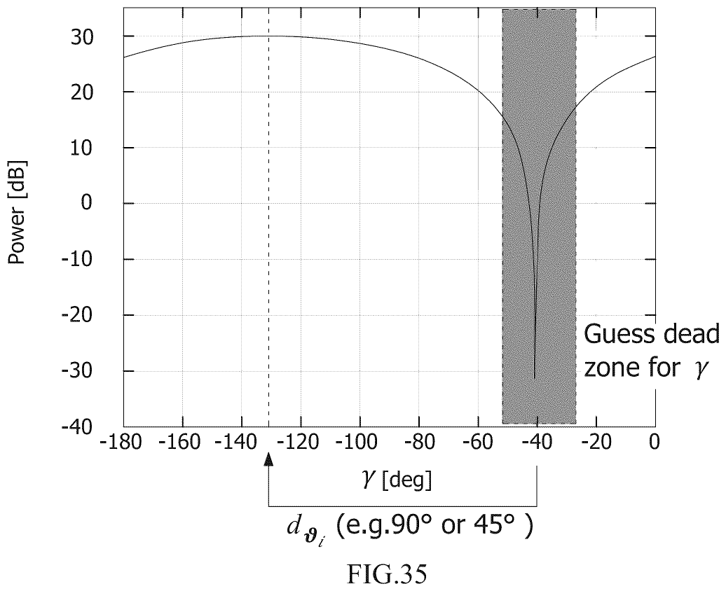

As shown in FIG. 35, the design of a temporary random guess of the estimate ϑᵢ=\hat{ϑ}ᵢ along an i^{th} search direction ϑᵢ is important. The probability of a failed random guess for ϑᵢ should be as low as possible, and the ratio of the guess dead zone to the entire search space range for ϑᵢ should also be minimized. A peak location along a spatially flat (i.e., decoupled) search direction can initially be approximated using a temporary random guess. Then, peak location detection under the above temporary random guess, which induces a slight deformation of the overall receive (Rx) beamforming output power profile (manifested as a minor power level degradation, as shown in FIG. 29), is performed in a retrograded search space. The performance degradation caused by the above random guess within a dead zone is limited, for example, an with approximately 3% probability for a 20% power reduction. The system checks whether the receive (Rx) beamforming (BF) output power Pᵣₓ satisfies the following minimum required power condition Pₘᵢₙ:

$${P}_{r x} \leq {P}_{min}$$

If Pᵣₓ≤Pₘᵢₙ, then the system generates another guess based on the previous estimate (random guess) with a specific angular displacement d_{ϑ}_{ᵢ} and re-execute the search process.

### APPENDIX: ARRAY INDEX MAPPING

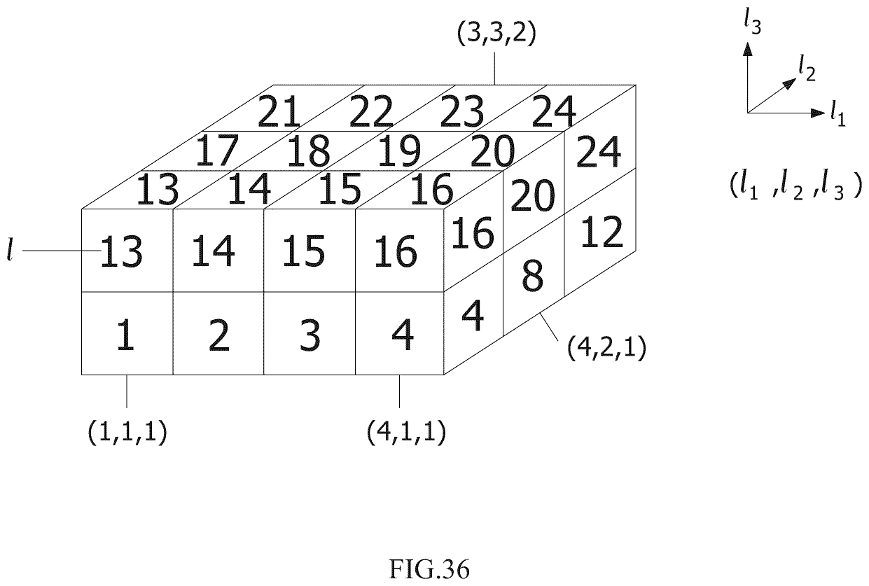

Array Index Mapping: The conversion (mapping) between one-dimensional (1D) and three-dimensional (3D) indices as shown in FIG. 36. This mapping is based on the following relationships.

Defining {\tilde{ϑ}}ₗ≡[{\tilde{ϑ}₁}ₗ_{₁},{\tilde{ϑ}₂}ₗ_{₂},{\tilde{ϑ}₃}ₗ_{₂}]^{T}∈ [symbol] ³, where l=1, . . . , N_{F}, lᵢ=1, . . . . Nᵢ, and i=1, 2, 3. The mapping between the 3D and 1D indices is given by:

$$l = map ( ( {l}_{1} , {l}_{2} , {l}_{3} ) ) , and ( {l}_{1} , {l}_{2} , {l}_{3} ) = map ( l ) .$$

### Example 1: Converting 3D Indices to 1D Index

Given (x,y,z)=(2,3,2) and the lengths Mₓ, M_{y}, M_{z} in x, y, z directions respectively are (Mₓ,M_{y},M_{z})=(3,3,2), search the 1D index i:

$$i = x + {M}_{x} ( ( y - 1 ) + {M}_{y} ( z - 1 ) ) = 2 + 3 ( ( 3 - 1 ) + 3 ( 2 - 1 ) ) = 17 .$$

### Example 2: Converting 1D Index to 3D Indices

Given i=17 and (Mₓ,M_{y},M_{z})=(3,3,2), search the 3D index (x,y,z):

$$z = ⌈ \frac{i}{{M}_{x} {M}_{y}} ⌉ = ⌈ \frac{17}{9} ⌉ = 2 ,$$

$$y = ⌈ \frac{i - ( z - 1 ) {M}_{x} {M}_{y}}{{M}_{x}} ⌉ = ⌈ \frac{17 - ( 2 - 1 ) 9}{3} ⌉ = 3 ,$$

$$x = i - {M}_{x} ( ( y - 1 ) + {M}_{y} ( z - 1 ) ) = 17 - 3 ( ( 3 - 1 ) + 3 ( 2 - 1 ) ) = 2 .$$

### Example 3: Converting 2D Indices to 1D Index

Given (x,y)=(2,3), (Mₓ,M_{y})=(3,3), and z=M_{z}=1, search the 1D index i:

$$i = x + {N}_{x} ( ( y - 1 ) + {N}_{y} ( z - 1 ) ) = 2 + 3 ( ( 3 - 1 ) + 3 ( 1 - 1 ) ) = 8 .$$

### Example 4: Converting 1D Index to 2D Indices

Given i=8, (Mₓ,M_{y})=(3,3), and z=M_{z}=1, search the 2D index (x,y):

$$y = ⌈ \frac{i}{{M}_{x}} ⌉ = ⌈ \frac{8}{3} ⌉ = 3 ,$$

$$x = i - {M}_{x} ( ( y - 1 ) ) = 8 - 3 ( ( 3 - 1 ) ) = 2 .$$

The present invention employs spatial decoupling to separate the joint/full three-dimensional (3D) search space S_{F} into low-dimensional search spaces, significantly reducing the number of searches, computational resource consumption, and search time, thereby minimizing search complexity.

The multi-stage peak location detection (MSPLD), combined with progressively reduced search step sizes, enables the system to complete peak positioning with fewer iterations, shortening the initial search time and enhancing overall search efficiency.

By performing interactive peak location detection between the retrograded space and the decoupled space, followed by final result reconstruction, the present invention effectively mitigates error accumulation from single-space detection, enhancing the accuracy of the final peak location.

Through the design of angular hopping and random-guess mechanisms, the present invention reduces the probability of search failure when the peak falls into a low-power region, thereby improving system robustness and avoiding power dead-zone issues.

The present invention is particularly suitable for initial searches in Geosynchronous Earth Orbit (GEO) systems. In dynamic communication scenarios, it enables a mobile user terminal to quickly and stably establish an initial link with a target satellite during the cold-start phase.

What is claimed is:

1. A spatial decoupling method for initial searches in geosynchronous earth orbit (GEO) systems, comprising the following steps executed in sequence:
Step 1: analyzing a spatial selectivity of a receive beamforming output and decoupling at least one decoupled search space from a joint/full three-dimensional (3D) search space;
Step 2: based on peak location guesses from the decoupled search space, establishing and forming a corresponding retrograded search space, and performing a first peak location detection in the retrograded search space;
Step 3: based on detection results of the first peak location detection, performing a second peak location detection in the decoupled search space; and
Step 4: integrating peak location detection results from the decoupled search space and the retrograded search space to reconstruct a final peak location.

2. The spatial decoupling method for initial searches in geosynchronous earth orbit systems according to claim 1, wherein the decoupling in Step 1 is based on spatial selectivity analysis of a beam pattern on a continuous mechanical angular scale to obtain corresponding spatial Degrees-of-Freedom (DoF).

3. The spatial decoupling method for initial searches in geosynchronous earth orbit systems according to claim 1, wherein the retrograded search space corresponds to an equivalent retrograded receive beamforming output power obtained after pre-specifying part of variables in a joint objective function corresponding to the joint/full three-dimensional search space.

4. The spatial decoupling method for initial searches in geosynchronous earth orbit systems according to claim 1, wherein in Step 3, search parameters for non-detection directions are assigned temporary random guess values or pre-specified estimate values, and the peak location is re-detected in the decoupled search space.

5. The spatial decoupling method for initial searches in geosynchronous earth orbit systems according to claim 1, wherein the integrating in Step 4 is performed through a multi-stage peak location detection (MSPLD) procedure, the multi-stage detection comprising at least two search stages with different step sizes configured to progressively narrow a search range and improve detection accuracy.

6. The spatial decoupling method for initial searches in geosynchronous earth orbit systems according to claim 1, wherein angular hopping is performed in the first peak location detection or in the second peak location detection to avoid power dead zones during the detection process.

7. The spatial decoupling method for initial searches in geosynchronous earth orbit systems according to claim 5, wherein the search step size is configured to decrease progressively, such that a larger step size is used in an initial stage and a smaller step size is used in subsequent stages.

8. The spatial decoupling method for initial searches in geosynchronous earth orbit systems according to claim 1, further comprising, after completion of Step 4, confirming whether a receive beamforming output power satisfies a minimum required power condition, and if the receive beamforming output power is less than or equal to the minimum required power condition, setting another guess with a specific angular displacement based on a peak location guess from the decoupled search space and re-executing Steps 2, 3, and 4 in sequence.
